(19) United States
(12) Patent Application Publication
(10) Pub. No.: US 2026/0270398 A1
(43) Pub. Date: Sep. 10, 2026

(54) ANGULAR WEIGHTED PREDICTION

(71) Applicant: Alibaba (China) Co., Ltd., Hangzhou (CN)

(72) Inventors: Li Yu, Wuhan (CN); Jiabao Zhu, Wuhan (CN); Wanglin Lai, Wuhan (CN); Hongbo Li, Wuhan (CN); Yucheng Zhong, Wuhan (CN); Jie Chen, Beijing (CN); Ru-ling Liao, Sunnyvale, CA (US); Yan Ye, San Diego, CA (US)

(21) Appl. No.: 19/553,079

(22) Filed: Feb. 27, 2026

Related U.S. Application Data
(60) Provisional application No. 63/768,984, filed on Mar. 8, 2025.

(51) Int. Cl. H04N 19/105; H04N 19/132; H04N 19/139; H04N 19/172; H04N 19/176; H04N 19/52

(52) U.S. Cl. CPC H04N 19/105; H04N 19/132; H04N 19/139; H04N 19/172; H04N 19/176; H04N 19/52

(57) ABSTRACT

An AVS3 and later-standard encoder and an AVS3 and later-standard decoder are provided, configuring one or more processors of a computing system to perform angular weighted prediction. The encoder and the decoder are configured to implement performing angular weighted prediction by constructing motion vector candidate lists including more MV candidates and additional types of MV candidates, and extending the candidate list length; by performing template matching based on reconstructed pixels surrounding the current block to reorder the MV candidates; and by performing motion vector refinement based on template matching to partitions of the current block.

### CROSS-REFERENCE TO RELATED APPLICATIONS

This application claims benefit of and priority to U.S. Patent Application No. 63/768,984, filed Mar. 8, 2025, which is hereby incorporated by reference in its entirety for all purposes as if fully set forth herein.

### BACKGROUND

The Audio and Video coding standard workgroup (“AVS workgroup”) in China has adopted the third-generation Audio and Video coding standard (“AVS3”). AVS3 was preceded by AVS1 and AVS2, issued as China national standards in the years of 2006 and 2016, respectively. In December 2017, a call for proposals formally started AVS3 development, and in December 2018, High Performance Model (“HPM”) was chosen as a new reference software platform for AVS3 standard development. The initial technologies in HPM was inherited from AVS2 standard, and based on that, more performance improvements were made. In 2019, the first phase of the AVS3 standard was finalized, achieving over 20% coding performance gain compared with AVS2, while the second phase of AVS3 development is ongoing.

According to AVS3, an encoder and a decoder partition picture data into blocks, and perform motion prediction upon luma and chroma components of the blocks by selecting one among various intra prediction and inter prediction modes. AVS3 provides angular weighted prediction (“AWP”), where, to efficiently code boundaries and edges of objects in a picture, any particular block of a picture can be internally partitioned into two irregular partitions by a partitioning line spanning two edges of the block.

Presently, the AVS workgroup is reviewing draft proposals for subsequent improvements over AVS3 techniques to be included in the successor AVS4 standard. There is a need to further improve the implementation of angular weighted prediction as provided by the AVS3 and later standards.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, a video encoding process and a video decoding process according to example embodiments of the present disclosure.

FIG. 2 illustrates temporal motion vector predictor (“TMVP”) derivation according to AVS3 and later standards.

FIG. 3 illustrates neighboring blocks used for spatial motion vector predictor (“SMVP”) derivation according to AVS3 and later standards.

FIG. 4 illustrates prediction directions of a motion vector angular predictor (“MVAP”) according to AVS3 and later standards.

FIG. 5 illustrates MVAP reference blocks according to AVS3 and later standards.

FIGS. 6A and 6B illustrate motion derivation in ultimate motion vector expression (“UMVE”) mode according to AVS3 and later standards.

FIG. 7 illustrates weight prediction according to angular weighted prediction (“AWP”) according to AVS3 and later standards.

FIG. 8 illustrates intra prediction angles according to AWP according to AVS3 and later standards.

FIG. 9 illustrates weight array settings according to AWP according to AVS3 and later standards.

FIG. 10 illustrates collocated sub-blocks for candidate pruning according to AVS3 and later standards.

FIGS. 11A and 111B illustrate a control point-based affine model according to AVS3 and later standards.

FIG. 12 illustrates affine motion vectors of sub-blocks calculated for each sub-block center sample according to AVS3 and later standards.

FIG. 13 illustrates an integer position search according to Decoder-side Motion Vector Refinement (“DMVR”), according to AVS3 and later standards.

FIG. 14 illustrates a sub-pixel estimation at an optimal integer position according to DMVR, according to AVS3 and later standards.

FIG. 15 illustrates local luma compensation (“LIC”) model parameter estimation based on neighboring blocks in a reference picture and a current picture, according to AVS3 and later standards.

FIG. 16 illustrates LIC model parameter estimation based on neighboring blocks in a current picture only, according to AVS3 and later standards.

FIGS. 17A through 17D illustrate four pairs of samples used for LIC model parameter estimation, according to AVS3 and later standards.

FIG. 18 illustrates an inter template matching template shape according to AVS3 and later standards.

FIGS. 19A and 19B illustrate a hexagonal search pattern and a square-shape search pattern in inter template matching according to AVS3 and later standards.

FIG. 20 illustrates a sigmoid function which derives sample weights according to Adaptive Angular Weighted Prediction (“AAWP”) for successor standards to AVS3.

FIG. 21A illustrates a template of a reference block and FIG. 21B illustrates a template of a current block according to AVS3 and later standards.

FIG. 22 illustrates spatial extension candidates for the null domain expansion of a 128×128 largest coding unit (“LCU”), where each x denotes a left, top left, or top neighbor block to be checked according to AVS3 and later standards.

FIG. 23A illustrates a top template of a current block and FIG. 23B illustrates a left template of a current block according to AVS3 and later standards.

FIG. 24 illustrates an example system for implementing the processes and methods described herein for implementing angular weighted prediction.

### DETAILED DESCRIPTION

Systems and methods discussed herein are directed to implementing angular weighted prediction, and more specifically performing angular weighted prediction by constructing motion vector candidate lists including more MV candidates and additional types of MV candidates, and extending the candidate list length; by performing template matching based on reconstructed pixels surrounding the current block to reorder the MV candidates; and by performing motion vector refinement based on template matching to partitions of the current block.

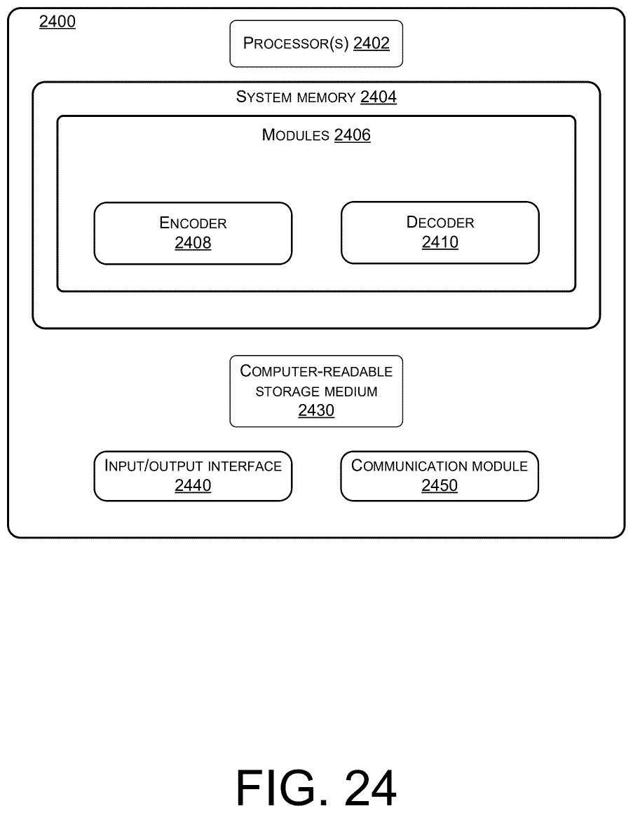

In accordance with AVS3 and later video coding standard (“AVS3 and later standard”), and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 24, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by AVS3 and later standards, and operations of a decoder as described by AVS3 and later standards. Some of these encoder operations and decoder operations according to AVS3 and later standards are subsequently described in further detail, though these subsequent descriptions should not be understood as exhaustive of encoder operations and decoder operations according to AVS3 and later standards. Subsequently, an “AVS3 and later-standard encoder,” and an “AVS3 and later-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, an AVS3 and later-standard encoder an AVS3 and later-standard decoder further include computer-readable instructions stored on a computer-readable storage medium which are executable by one or more processors of a computing system to configure the one or more processors to perform operations not specified by AVS3 and later standards. An AVS3 and later-standard encoder should not be understood as limited to operations of a reference implementation of an encoder, but including further computer-readable instructions configuring one or more processors of a computing system to perform further operations as described herein. An AVS3 and later-standard decoder should not be understood as limited to operations of a reference implementation of a decoder, but including further computer-readable instructions configuring one or more processors of a computing system to perform further operations as described herein.

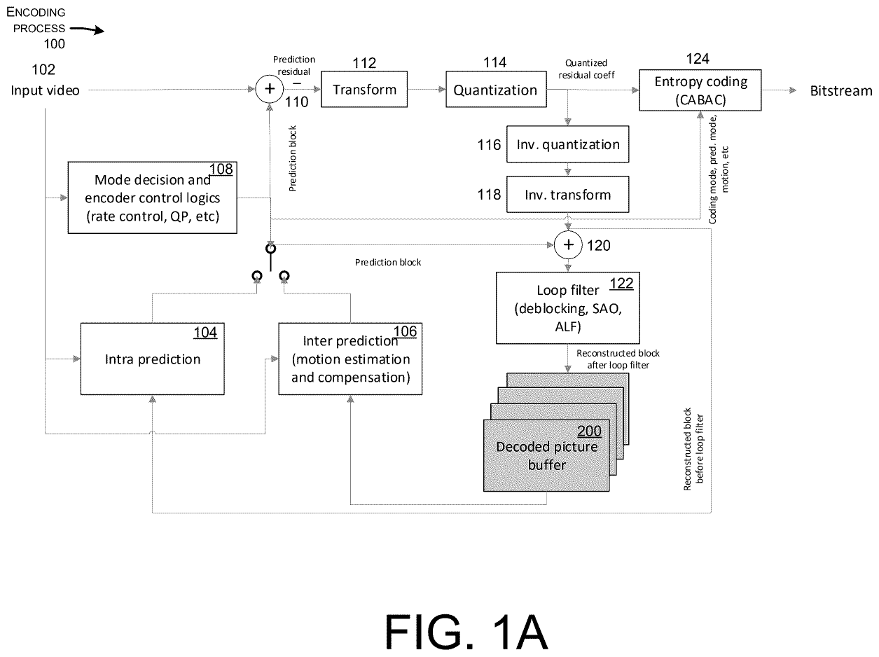

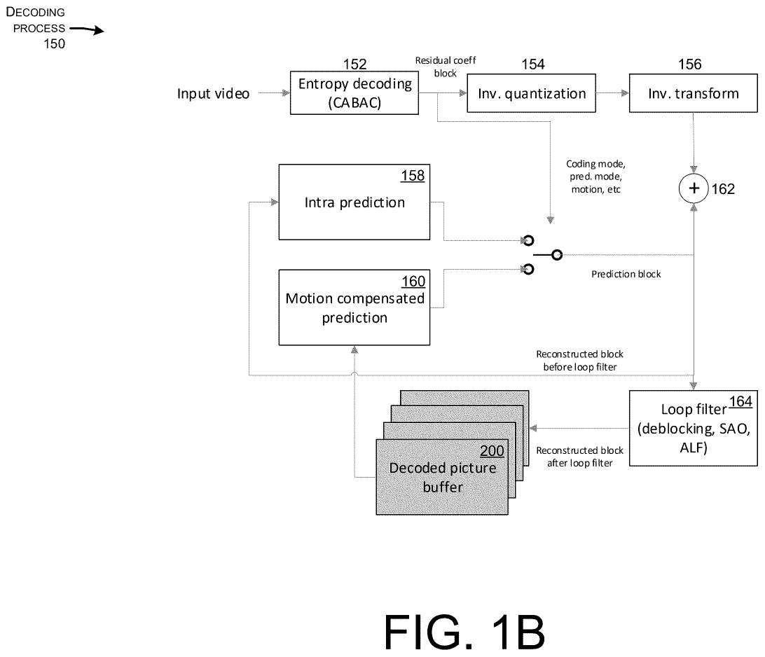

FIGS. 1A and 1B illustrate example block diagrams of, respectively, an encoding process 100 and a decoding process 150 according to an example embodiment of the present disclosure.

In an encoding process 100, an AVS3 and later-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. An AVS3 and later-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

An AVS3 and later-standard encoder encodes a picture (a picture being encoded being called a “current picture,” as distinguished from any other picture received from an image source 102) by configuring one or more processors of a computing system to partition the original picture into units and subunits according to a partitioning structure. An AVS3 and later-standard encoder configures one or more processors of a computing system to subdivide a picture into macroblocks (“MBs”) each having dimensions of 16×16 pixels, which can be further subdivided into partitions. An AVS3 and later-standard encoder configures one or more processors of a computing system to subdivide a picture into coding tree units (“CTUs”), the luma and chroma components of which can be further subdivided into coding tree blocks (“CTBs”) which are further subdivided into coding units (“CUs”). Alternatively, an AVS3 and later-standard encoder configures one or more processors of a computing system subdivide a picture into units of N×N pixels, which can then be further subdivided into subunits. Each of these largest subdivided units of a picture can generally be referred to as a “block” for the purpose of this disclosure.

A CU is coded using one block of luma samples and two corresponding blocks of chroma samples, where pictures are not monochrome and are coded using one coding tree.

An AVS3 and later-standard encoder configures one or more processors of a computing system to subdivide a block into partitions having dimensions in multiples of 4×4 pixels. For example, a partition of a block can have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, an AVS3 and later-standard encoder configures one or more processors of a computing system to encode color information of a picture at a lower resolution than the input picture, storing the color information in fewer bits than the input picture.

Furthermore, an AVS3 and later-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs can refer to a unit or multiple subunits corresponding to a block structure among multiple block structures of a picture, such as an MB or a CTU, wherein blocks are partitioned based on the picture data and are coded according to AVS3 and later standards. Motion information corresponding to a PU can describe motion prediction as encoded by a AVS3 and later-standard encoder as described herein.

An AVS3 and later-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction can further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

An AVS3 and later-standard encoder configures one or more processors of a computing system to code a CU to include reference indices to identify, for reference of an AVS3 and later-standard decoder, the prediction signal(s) of the current block. One or more processors of a computing system can code a CU to include an inter prediction indicator. An inter prediction indicator indicates list 0 prediction in reference to a first reference picture list referred to as reference picture list 0 (“RPL0”), list 1 prediction in reference to a second reference picture list referred to as reference picture list 1 (“RPL1”), or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

An AVS3 and later-standard encoder configures one or more processors of a computing system to code each current block of a picture individually, outputting a prediction block for each. According to AVS3 and later standards, a CTU can be as large as 128×128 luma samples (plus the corresponding chroma samples, depending on the chroma format). A CTU can be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, an AVS3 and later-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

AVS3 and later standards provide semantics for recording coding parameter sets for a CU. It should be understood that AVS3 and later standards include semantics for recording various information, flags, and options.

An AVS3 and later-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

An AVS3 and later-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, an AVS3 and later-standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients can refer to coefficients representing one of several spatial transformations, such as a diagonal flip, a vertical flip, or a rotation, which can be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above.

An AVS3 and later-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

An AVS3 and later-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

An AVS3 and later-standard encoder further implements an adder 120. One or more processors of a computing system are configured to perform an addition operation by adding a prediction block and a reconstructed residual, outputting a reconstructed block.

An AVS3 and later-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

An AVS3 and later-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

An AVS3 and later-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

An AVS3 and later-standard encoder configures one or more processors of a computing system to output a coded picture, made up of coded blocks from the entropy coder 124. The coded picture is output to a transmission buffer, where it is ultimately packed into a bitstream for output from the AVS3 and later-standard encoder. The bitstream is written by one or more processors of a computing system to a non-transient or non-transitory computer-readable storage medium of the computing system, for transmission.

In a decoding process 150, an AVS3 and later-standard decoder configures one or more processors of a computing system to receive, as input, one or more coded pictures from a bitstream.

An AVS3 and later-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

An AVS3 and later-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the AVS3 and later-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the AVS3 and later-standard decoder configures one or more processors of a computing system to perform intra prediction 158 using prediction information specified in the coding parameter sets. The intra prediction 158 thereby generates a prediction signal.

In the event that the coding parameter sets specify inter prediction, the AVS3 and later-standard decoder configures one or more processors of a computing system to perform motion compensated prediction 160 using a reference picture from a DPB 200. The motion compensated prediction 160 thereby generates a prediction signal.

An AVS3 and later-standard decoder further implements an adder 162. The adder 162 configures one or more processors of a computing system to perform an addition operation on the reconstructed residuals and the prediction signal, thereby outputting a reconstructed block.

An AVS3 and later-standard decoder further implements a loop filter 164. One or more processors of a computing system are configured to apply a loop filter, such as a deblocking filter, a SAO filter, and ALF to a reconstructed block, outputting a filtered reconstructed block.

An AVS3 and later-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

An AVS3 and later-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, an AVS3 and later-standard encoder and an AVS3 and later-standard decoder each implements motion prediction coding in accordance with AVS3 and later specifications. An AVS3 and later-standard encoder and an AVS3 and later-standard decoder each configures one or more processors of a computing system to generate a reconstructed picture based on a previous reconstructed picture of a DPB according to motion compensated prediction as described by AVS3 and later standards, wherein the previous reconstructed picture serves as a reference picture in motion compensated prediction as described herein.

For inter prediction, a reference index indicates which previously coded picture the reference block is from and the motion vector (“MV”) which is the position difference between the reference block in the reference picture and the current block in the current picture is used to indicate the position of the reference block in the reference picture. For bi-prediction, two reference blocks, one from a reference picture in reference picture list 0 and the other from another reference picture in reference picture list 1 are used to generate the combined predicted block. Thus, two reference indices, a list 0 reference index and a list 1 reference index, and two motion vectors, list 0 motion vector and a list 1 motion vector are needed for bi-prediction. The motion vector is determined by the encoder and signaled to the decoder. To minimize signaling cost, the motion vector difference (“MVD”) is signaled instead. For a decoder, a motion vector predictor (“MVP”) is derived based on the spatial and temporal neighboring block motion information and the MV is obtained by adding the MVD which is parsed from the bitstream to the MVP.

AVS3 and later standards provide multiple inter prediction modes, including direct mode, skip mode, and inter modes. For skip mode and direct mode, motion information, including reference index and motion vector, is not signaled in the bitstream but derived at decoder-side with a same rule as encoder does. These two modes share the same motion information derivation rule. They differ in that skip mode skips the signaling of the residuals by setting residuals to be zero, but direct modes still has residuals signaled in the bitstream.

Compared to inter modes, bits dedicated to motion information can be spared in skip mode and direct mode, but the encoder follows AVS3 and later standard specifications to derive the motion vector and reference index to perform inter prediction, while in inter modes the encoder can choose any allowed values for motion vector and reference index as the motion vector difference and reference index are signaled. Thus, skip mode and direct mode are suitable when motion information of the current block is close to that of spatial or temporal neighboring block, since the derivation of the motion information is based on the spatial or temporal neighboring block.

To derive motion information used in inter prediction in skip mode and direct mode, an AVS3 and later-standard encoder derives a motion candidate list, then selects a motion candidate of the list to perform the inter prediction. The index of the selected candidate is signaled in the bitstream. An AVS3 and later-standard decoder derives the same motion candidate list as the AVS3 and later-standard encoder, uses the index parsed from the bitstream to get the motion (including motion vector and reference index) used for inter prediction, then performs inter prediction.

Currently, AVS3 and later standards provide 12 candidates in the normal motion candidate list, including temporal candidates (namely temporal motion vector predictors), spatial candidates (namely spatial motion vector predictors), sub-block-based spatial candidates (namely motion vector angular predictors) and history-based candidates (namely history-based motion vector predictors).

The first candidate, the temporal motion vector predictor (“TMVP”), is derived from the MV of the collocated block in a particular reference frame. The particular reference frame here is specified as the reference frame with reference index being 0 in list 1 for a B frame or list 0 for a P frame. When the MV of the collocated block is unavailable, an MVP derived according to the MV of spatially neighboring blocks is used as a block-level TMVP.

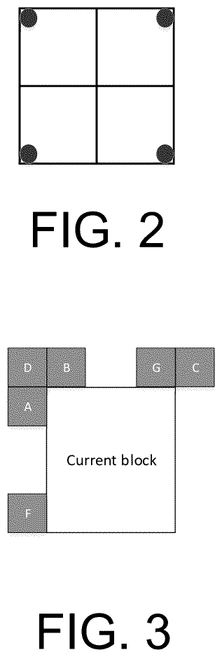

AVS3 and later standards also adopt subblock-level TMVPs. When subblock TMVPs derivation is enabled, the current block is split 2×2 into 4 subblocks as illustrated in FIG. 2, and a motion vector is derived for each subblock. As shown in FIG. 2, for each subblock, a corner sample is used to find the collocated block in the reference picture. A motion vector stored in the temporal motion information buffer covering the sample with the same coordinator in the reference picture as the corner sample is fetched and scaled. The scaled motion vector is used as the TMVP of each subblock. If the list 0 motion vector in the temporal motion information buffer is available (which means the collocated block has a list 0 motion vector), the list 0 motion vector is used; otherwise, if the list 1 motion vector in the temporal motion information buffer is available (which means the collocated block does not have a list 0 motion vector, but has a list 1 motion vector), the list 1 motion vector is used; otherwise, a block-level TMVP is derived and used as the TMVP for the current subblock.

Subblock TMVPs can only be derived for blocks whose width and height are both greater than or equal to 16.

The second, third and fourth candidates are the spatial motion vector predictors (“SMVPs”) derived from the 5 neighboring blocks F, G, C, B, A, D as illustrated in FIG. 3. The second candidate is a bi-prediction candidate, the third candidate is an uni-prediction candidate with reference frame in list 0, and the fourth candidate is an uni-prediction candidate with reference frame in list 1. These three candidates borrow the MV and reference index of the first available block among the six neighboring blocks which has the same prediction type as the current candidate motion information the order of F, G, C, B, A, D.

For the second candidate, the motion information of the first block using bi-prediction is borrowed. If there is no such block and there is more than one neighboring block using uni-prediction with reference picture list 0 and more than one neighboring block using uni-prediction with reference picture list 1, then for the second candidate, the motion information of the first block using uni-prediction with reference picture list 0 and the motion information of the first block using uni-prediction with reference picture list 1 in the order of F, G, C, B, A, D are jointly borrowed to get the motion vector and reference index for the second candidate; otherwise, the motion vector and reference index are both set to zero.

For the third candidate, the motion information of the first block using uni-prediction with reference picture list 0 is borrowed. If there is no such block among the six neighboring blocks and there is more than one neighboring block using bi-prediction, then for the third, the list 0 motion information of the first bi-prediction block in the order of D, B, A, C, G, F are borrowed; otherwise the motion vector and reference index are both set to zero.

For the fourth candidate, the motion information of the first block using uni-prediction with reference picture list 1 is borrowed. If there is no such block among the six neighboring blocks and there is more than one neighboring block using bi-prediction, then for the fourth candidate, the list 1 motion information of the first bi-prediction block in the order of D, B, A, C, G, F are borrowed; otherwise the motion vector and reference index are both set to zero.

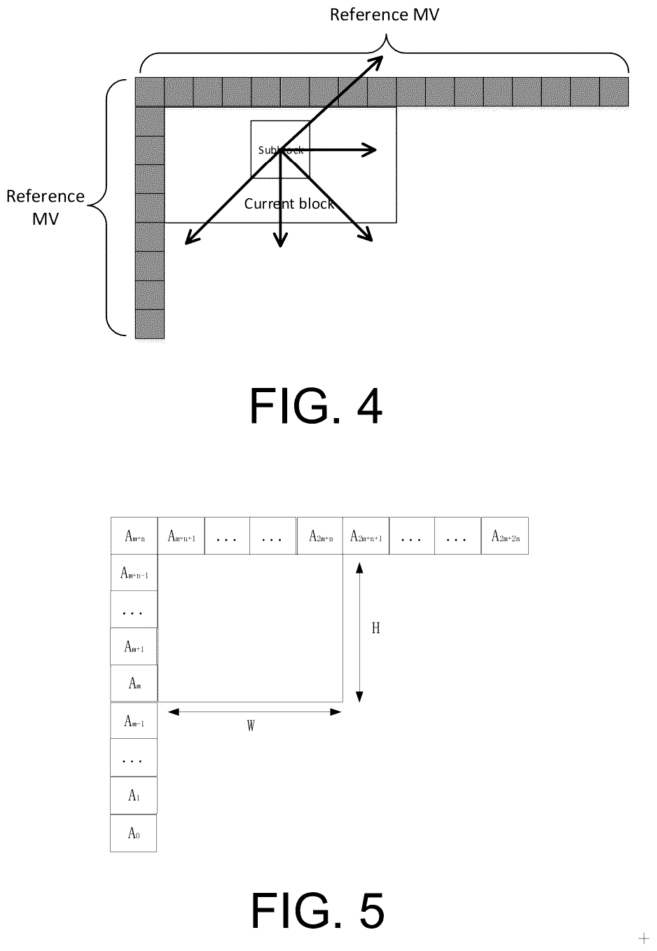

Motion vector angular predictor (“MVAP”) candidates follow the SMVPs. There are at most five MVAP candidates, which can be the fifth to the ninth candidates. The MVAP candidates are derived by angular prediction in five difference directions from the reference motion information which are the MVs and reference indices of the neighboring blocks as illustrated in FIG. 4. The reference motion information is first checked at 4×4 block-level. The neighboring 4×4 blocks to be checked are indicated in FIG. 5. If the motion information in a 4×4 neighboring block is not available, it is filled with neighboring available MV and reference index.

Availability of five directions will also be checked by comparing the reference motion information. Only available directions are used to predict the MV of each 8×8 subblock within the current block, resulting in a number of MVAP candidates between 0 to 5. The first MVAP candidate is available only when A_{m-1+H/8} and Aₘ₊ₙ₋₁ have different motion information. The second MVAP candidate is available only when A_{m+n+1+W/8} and Aₘ₊ₙ₊₁ have different motion information. The third MVAP candidate is available only when Aₘ₊ₙ₋₁ and Aₘ₊ₙ have different motion information. The fourth MVAP candidate is available only when A_{W/8-1} and Aₘ₋₁ have different motion information. The fifth MVAP candidate is available only when A_{m+n+1+W/8} and A₂ₘ₊ₙ₊₁ have different motion information.

Since the MV prediction is applied to each 8×8 subblock within the current block, the MVAP candidate is a subblock-level candidate, which means different subblocks within the current block may have different MVs and reference indices.

History-based motion vector predictor (“HMVP”) candidates follow MVAP candidates. HMVP candidates are derived from motion information of the previously encoded or decoded blocks. After encoding or decoding an inter coded block, the motion information is inserted as a last entry of a HMVP table, wherein the size of the HMVP table is set to 8. If there are already 8 candidates in the table, the first candidate is removed when the current motion information is inserted into the table to maintain the number of the candidates in the table is no greater than 8.

Additionally, when inserting a new candidate, a redundancy check is first applied. If there is already an identical motion candidate in the table, this identical motion candidate is moved to the last entry of the table instead of inserting the new one to avoid redundancy among candidates in the table.

Candidates in the HMVP table are used as HMVP candidates for skip mode and direct mode. The HMVP table is checked from the last entry to the first entry. If a candidate in HMVP table is identical to either the TMVP candidate or any SMVP candidate already in the skip mode and direct mode candidate list, this candidate is not put into the skip mode and direct mode candidate list; if a candidate in HMVP table is not identical to any TMVP candidate or SMVP candidate already in the skip mode and direct mode candidate list, the candidate in HMVP table is put into the skip mode and direct mode candidate list as a HMVP candidate. Subsequently, this process referred to as “pruning.” The candidates in the HMVP table is checked one by one until the normal skip mode and direct mode candidate list is full, or all the candidates in the HMVP table are checked.

After inserting the HMVP candidates, if the normal skip mode and direct mode candidate list is still not full, the last candidate is repeated until the candidate list is full.

In addition to skip mode and direct mode, where the implicitly derived motion information is used to find the reference block for inter prediction, ultimate motion vector expression (“UMVE”) is also adopted in AVS3 and later standards as another method to derive motion information.

According to UMVE, based on a base candidate index signaled in the bitstream, a base motion candidate is selected from a UMVE candidate list containing only two candidates. Then, the base motion candidate is further refined according to signaled MVD offset information, including a distance index specifying MVD offset distance, and a direction index indicating MVD offset direction. The base motion vector is set as the starting point for the refinement.

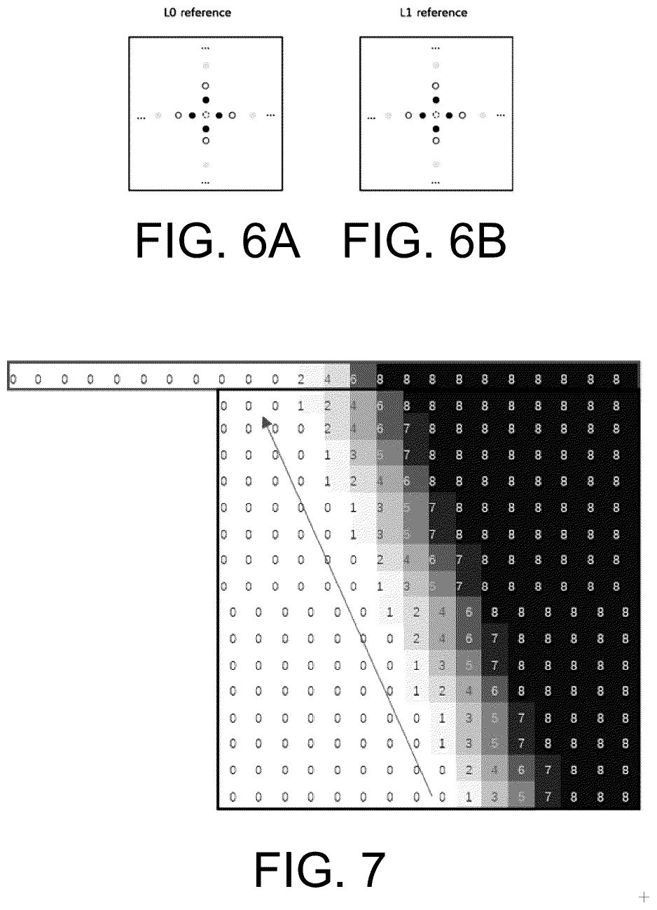

The direction index represents the direction of the MVD offset relative to the starting point, and can represent one of the four directions as illustrated in FIGS. 6A and 6B. The distance index specifies MVD offset magnitude information. The relationship of the distance index and pre-defined MVD offset value is specified in Table 1 (five MVD offsets) and Table 2 (eight MVD offsets) below. A flag is signaled in the picture header to determine whether to use Table 1 or Table 2.

| MVD offset index | 0 | 1 | 2 | 3 | 4 |
|---|---|---|---|---|---|
| MVD offset (pel) | ¼ | ½ | 1 | 2 | 4 |

| MVD offset index | 0 | 1 | 2 | 3 | 4 | 5 | 6 | 7 |
|---|---|---|---|---|---|---|---|---|
| MVD offset (pel) | ¼ | ½ | 1 | 2 | 4 | 8 | 16 | 32 |

According to AVS3 and later standards, an angular weighted prediction (“AWP”) mode is adopted for skip mode and direct mode. AWP mode is indicated by a flag signaled in the bitstream. According to AWP mode, a motion vector candidate list, which contains five different uni-prediction motion vectors derived from spatially neighboring blocks and temporal motion vector predictor, is constructed. To construct the uni-prediction candidate list, the motion information of temporal collocated block, denoted as T, and the spatially neighboring block F, G, C, A, B, D illustrated by FIG. 3 are inserted into the candidate list in order.

If the neighboring block is a uni-prediction block, the motion information is directly inserted into the candidate list; if the neighboring block is a bi-prediction block, according to the current candidate index parity, only the list 0 motion information or the list 1 motion information is inserted. After inserting all the neighboring motion information, if the candidate list is not full, additional candidates are derived based on the existing candidate in the list until the candidate list is full. After uni-prediction candidate list in constructed, two uni-prediction motion vectors are selected from the motion vector candidate list according to the two candidate indices signaled in the bitstream to get the two reference blocks.

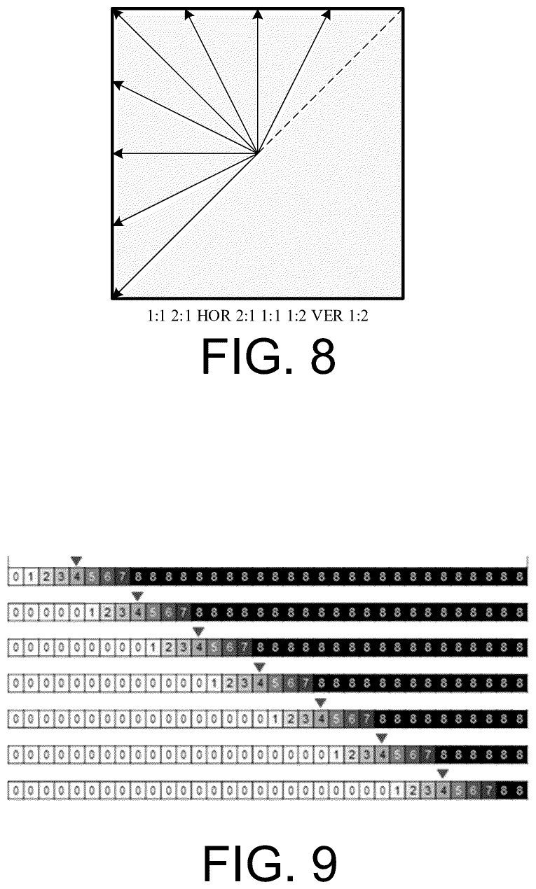

After getting the reference blocks, unlike the traditional bi-prediction inter mode where two reference blocks are averaged to get the final predicted block, AWP mode has different weights for different samples in the averaging process. A weight for each sample is predicted from a reference weight array and the value of the weight is from 0 to 8. Weight prediction is similar to the process of intra prediction mode, as illustrated in FIG. 7. For a coding block with size w×h equal to 2^{m}×2ⁿ wherein m,n∈{3 . . . 6}, eight prediction directions as illustrated in FIG. 8 and seven different reference weight arrays as illustrated in FIG. 9 are supported in AWP mode. In total, there are 56 weight distributions among the samples within the block.

After determining the weight for each sample, the final predicted block is derived by weighted averaging two reference block in sample wise. Denoting the two reference blocks as P0 and P1, and the weight matrix as W0 and W1, the final prediction block P is calculated according to Equation 1 as follows:

$$P = ( P 0 * W 0 + P 1 * ( [ 8 ] - W 0 ) ) >> 3$$

where “*” is the point product, and “[8]” represents a matrix with all the elements equal to 8 and having the same dimension as the weight matrix.

An enhanced temporal motion vector predictor (“ETMVP”) is another method to derive motion information in AVS3 and later standards, wherein the current block is divided into 8×8 subblocks and each subblock derives a motion vector based on the corresponding temporal neighboring block motion information. When the ETMVP flag signaled in the stream indicates ETMVP is enabled, a motion candidate list is constructed. Each candidate in the list contains multiple motion vectors, one for each 8×8 sub-block.

For the first candidate, the motion vector of each 8×8 subblock is derived from the motion vector of the corresponding collocated block in the reference picture with reference index equal to 0 in the reference picture list 0.

For the second candidate, the current block is shifted down by 8 samples, then the motion vector of each subblock is derived from corresponding collocated block of the shifted block in the reference picture with reference index equal to 0 in the reference picture list 0.

For the third candidate, the current block is shifted to the right by 8 samples, then the motion vector of each subblock is derived from corresponding collocated block of the shifted block in the reference picture with reference index equal to 0 in the reference picture list 0.

For the fourth candidate, the current block is shifted up by 8 samples, then the motion vector of each subblock is derived from corresponding collocated block of the shifted block in the reference picture with reference index equal to 0 in the reference picture list 0.

For the fifth candidate, the current block is shifted to the left down by 8 samples, then the motion vector of each subblock is derived from corresponding collocated block of the shifted block in the reference picture with reference index equal to 0 in the reference picture list 0.

The last four candidates are pruned by comparing the motion information of two pre-defined subblocks in the reference picture.

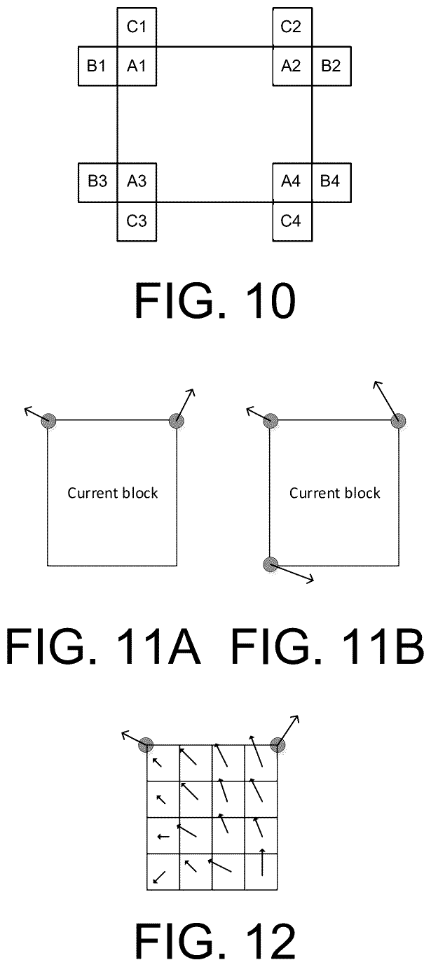

As illustrated in FIG. 10, for the second candidate, motion information of A2 and C4 is compared; for the third candidate, motion information of A3 and B4 is compared; for the fourth candidate, motion information of A4 and C2 is compared; and for the fifth candidate, motion information of A4 and B3 is compared. If motion information of two compared blocks is not the same, the candidate is valid and inserted into the candidate list. If the number of valid candidates is less than 5, the last candidate is repeated until the candidate number is 5.

The reference index of list 0 and list 1 for the current subblock are set to 0. If the collocated block is a list 0 uni-prediction block, the corresponding subblock also uses list 0 uni-prediction; if the collocated block is a list 1 uni-prediction block, the corresponding subblock also uses list 1 uni-prediction; if the collocated block is a bi-prediction block, the corresponding subblock also uses bi-prediction; and if the collocated block is an intra block, the motion vector of the corresponding subblock is set to a default motion vector which is derived from a spatially neighboring block.

After the candidate list is constructed, the candidate is selected by the candidate index which is signaled in the bitstream.

A motion vector represents object movement between two pictures at different time instances, but can only represent translational movement, as all the samples in the block have the same position shift. To compensate for other kinds of motion, such as zooming in/out and rotation, affine model-based motion compensation is adopted in AVS3 and later standards.

According to affine model-based motion compensation, different samples in the block have different motion vectors. The motion vector of each sample is derived from the motion vectors of the control points according to the affine model. Control points are usually set to the corner of the block. For a 4-parameter affine model, two control points are needed as illustrated in FIG. 11A, and for a 6-parameter affine model, three control points are needed as illustrated in FIG. 11B.

To reduce model computation complexity and motion compensation bandwidth, affine motion compensation granularity is changed from sample-level to subblock-level. In AVS3 and later standards, 4×4 or 8×8 luma subblock affine motion compensation is adopted wherein each 4×4 subblock or 8×8 subblock has a motion vector to perform motion compensation. To derive a motion vector of each 8×8 or 4×4 luma subblock, the motion vector of the center position of each subblock, as shown in FIG. 12, is calculated according to two or three control points (“CPs”), and rounded to 1/16 fraction accuracy. Then, motion compensation generates the prediction of each subblock with derived motion vectors.

Affine motion compensation is performed in two modes: affine inter mode, where motion vector differences of control points and reference indices are signaled in the bitstream, and affine skip mode and direct mode, where motion vector differences and reference indices are not signaled, but derived at decoder-side.

For affine skip mode and direct mode, the control point motion vectors (‘CPMVs”) of the current blocks are generated based on motion information of spatially neighboring blocks. There are five candidates in the affine skip mode and direct candidate list, and an index is signaled to indicate the candidate used for the current block. The affine skip mode and direct candidate list contains the following three types of candidates in order:
Inherited affine merge candidates, where the CPMVs of the current block are extrapolated from the CPMVs of the spatial neighbour blocks;
Constructed affine merge candidates, where the CPMVs of the current block are borrowed from translation MVs of the different neighboring blocks; and
Zero motion vectors.

There are at most two inherited affine candidates, which are derived from affine motion model of the neighboring blocks, one from left neighboring blocks and one from above neighboring blocks. When a neighboring affine block is identified, its CPMVs are used to derive the CPMV of the current block. For constructed affine candidate, CPMVs of the current block are constructed by combining motion information of different neighboring block. After inserting inherited affine candidates and constructed affine candidates into the affine skip mode and direct mode candidate list, if the list is still not full, zero MVs are inserted until the list is full.

For the affine inter mode, the difference of the CPMVs of current block and the index of CPMV predictors (“CPMVPs”) are signaled in the bitstream. An affine flag is signalled in the bitstream to indicate whether affine inter mode is used, and another flag is signalled to indicate whether 4-parameter affine or 6-parameter affine is used if affine inter mode is used. An affine CPMVP candidate list which has 2 candidates is constructed both at encoder-side and decoder-side. The candidate list is constructed by using the following four types of CPMVPs candidates in order:
Inherited affine candidates where the CPMVPs are extrapolated from the CPMVs of the neighbour blocks;
Constructed affine candidates where CPMVPs are derived from the translational motion vectors of the neighbour blocks;
Translational motion vectors from neighboring blocks;
Zero motion vectors.

The index of CPMVP is signaled in the bitstream to indicate which candidate is used as CPMVP for the current block, and the MVD signaled in the bitstream are added to the CPMVP to get the final value of CPMVs of the current block.

Affine motion compensation can only be applied on the block with the size greater than or equal to 16×16.

Instead of explicitly signaling an MVD in the bitstream, decoder-side motion vector refinement refines a motion vector at decoder-side according to symmetrical mechanism. Decoder-side motion vector refinement (“DMVR”) can only apply to a block with bi-prediction. The list 0 motion vector, MV0, and the list 1 motion vector, MV1, are derived first, then the refinement process is performed to refine the MV0 and MV1.

DMVR is performed based on 16×16 sub-blocks. Before performing bilateral matching, MV0 and MV1 are rounded to integer precision and set as initial MVs. The refinement is based on a search process. All samples used in the DMVR are within a window with size of (block width+7)*(block height+7). As 8-tap interpolation filter is used in normal motion compensation, setting the data window as (block width+7)*(block height+7) will not increase the memory bandwidth. The integer reference samples in the window are fetched from the reference picture of list 0 and list 1. The position on which the sum of difference of the list 0 reference block and list 1 reference block is minimized is set as the optimal integer position.

As illustrated by FIG. 13, the initial position referenced by the initial MV0 and MV1 are shaded. For each sub-block, 21 integer positions (as marked by triangle symbols) are searched. The position with the smallest SAD between the two reference blocks among 21 positions in the surrounding (2, −2) range is identified as the optimal integer position.

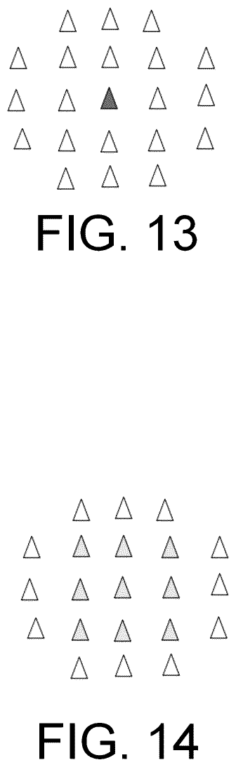

After the integer position search, if the optimal integer position is in the center 9 positions as shown in FIG. 14, sub-pixel estimation is performed, based on a mathematical model. According to the SAD values of the surrounding integer position, SAD values of sub-pixel positions are calculated. The sub-pixel position with the smallest SAD is obtained as a refined reference position.

DMVR is used for skip mode and direct mode, refining motion vectors to improve the prediction. DMVR is performed without signaling when the current block meets the following conditions:
The current block is a bi-prediction block;
The current block is in skip mode or direct mode;
The current block does not use the affine mode;
The current frame is located between the two reference frames;
The distance between the current frame and the two reference frames are the same; and
The width and height of the current block are greater than or equal to 8.

Bi-directional optical flow (“BIG”) is another method to refine the predicated sample values for the bi-prediction block in skip mode and direct mode. Whereas traditional bi-prediction performs a weighted average of two reference blocks to obtain the predicted block, BIO further refines the predicted block based on optical flow theory.

BIO is only applied to bi-prediction. BIO calculates gradient values in the horizontal direction and the vertical direction for each sample in the list 0 reference block and the list 1 reference block. To calculate the gradient, the current block is divided into 16×16 subblocks as with DMVR. For the boundary sample of the subblock, the gradient is calculated by padding the boundary sample of the subblock instead of fetching the actual sample out of the current subblock. After gradient calculation, refinement values are calculated for each sample based on the optical flow equation. To reduce computational complexity, it is assumed that each group of 4×4 samples share the same motion vector. Thus, each group has a refinement value. The refinement values are added to the predicted block to get the refined block.

In BIO, the gradient calculation uses an 8-tap filter, and its filter coefficients are shown in Table 3 below.

| MV position | coefficients |
|---|---|
| 0 | −4, 11, −39, −1, 41, −14, 8, −2 |
| ¼ | −2, 6, −19, −31, 53, −12, 7, −2 |
| ½ | 0, −1, 0, −50, 50, 0, 1, 0 |
| ¾ | 2, −7, 12, −53, 31, 19, −6, 2 |

No bitstream flag is signaled to indicate the use of BIO. BIO is applied for the blocks if all the following conditions are met:
BIO is only applied to luma component;
BIO is only applied to bi-prediction;
The forward reference frame and the backward reference frame are on both sides of the current frame; and
The current motion vector accuracy is quarter-pixel.

Bi-directional gradient correction (“BGC”) is another method to refine the predicted sample values for the bi-prediction block in inter mode. BGC calculates a difference between two reference blocks, one in a list 0 reference picture and the other in a list 1 reference picture, as the temporal gradient. The temporal gradient is scaled and added to the predicted block generated by two reference blocks to further correct the predicted block. For bi-prediction inter mode, the prediction block, Pred_{B1}, is generated by averaging the two reference blocks Pred₀ and Pred₁ which are obtained from the list 0 reference picture and the list 1 reference picture with two different motion vectors. According to BGC, the corrected prediction block Pred is calculated according to Equation 8 as follows:

$$Pred = \{ \begin{matrix}{Pred}_{BI} & , BgcFlag = 0 \\ {Pred}_{BI} + ( ( {Pred}_{1} - {Pred}_{0} ) >> k ) & , BgcFlag = 1 , BgcIdx = 0 \\ {Pred}_{BI} + ( ( {Pred}_{0} - {Pred}_{1} ) >> k ) & , BgcFlag = 1 , BgcIdx = 1\end{matrix}$$

where k is the correct intensity factor and is set to 3 in AVS3 and later standards. For a block that is coded in bi-prediction inter mode and satisfies the BGC application conditions, a flag, BgcFlag, is signaled to indicate whether BGC is used or not. When BGC is used, an index, BgcIdx, is further signaled to indicate how to correct the predicted block using temporal gradient. Both the BgcFlag and BgcIdx are signaled using context coded bins.

BGC is only applied to bi-prediction mode. For skip mode and direct mode, BgcFlag and BgcIdx are inherited from the neighboring block together with other motion information.

According to AVS3 and later standards, inter prediction filtering is the last stage in generating the final predicted block. Inter prediction filtering is only applied to predicted block coded with normal direct mode. If the current block is coded by normal direct mode, a flag is signaled to indicate whether InterPF is used or not. If InterPF is used, an index is signaled to indicate which filter is applied. Two filters can be selected by the encoder. At decoder-side, an AVS3 and later-standard decoder performs the same filter operation as encoder according to the syntax elements signaled in the bitstream.

When interPF is enabled, if the interPF index is equal to 0, the filtering process proceeds according to the following Equations 9, 10, 11, and 12. The left and above neighboring reconstructed samples are used to filter the current predicted samples by weighted averaging.

$$Pred ( x , y ) = ( Pred\_inter ( x , y ) \times 5 + Pred\_Q ( x , y ) \times 3 ) >> 3$$

$$Pred\_Q ( x , y ) = ( Pred\_V ( x , y ) + Pred\_H ( x , y ) + 1 ) >> 2$$

$$Pred\_V ( x , y ) = ( ( h - 1 - y ) \times R e c ( x , - 1 ) + ( y + 1 ) \times R e c ( - 1 , h ) + ( h >> 1 ) ) >> log2 ( h )$$

$$Pred\_H ( x , y ) = ( ( w - 1 - x ) \times R e c ( - 1 , y ) + ( x + 1 ) \times R e c ( w , - 1 ) + ( w >> 1 ) ) >> log2 ( w )$$

where Pred_inter(x, y) is the predicted sample to be filtered, Pred(x, y) is the filtered predicted sample, and (x, y) is the coordinate of the sample. Rec(x, y) represents the reconstructed neighboring pixels at position (x, y). The width and height of the current block are represented by w and h, respectively.

If the interPF index is equal to 1, filtering proceeds according to the following Equation 13:

$$Pred ( x , y ) = ( f ( x ) \times R e c ( - 1 , y ) + f ( y ) \times R e c ( x , - 1 ) + ( 64 - f ( x ) - f ( y ) ) \times Pred\_inter ( x , y ) + 32 ) >> 6$$

where Pred_inter(x, y) is the predicted sample to be filtered, Pred(x, y) is the filtered predicted sample, and (x, y) is the coordinate of the sample. Rec(x, y) represents the reconstructed neighboring pixels at position (x, y). f(x) and f(y) can be obtained by a lookup table as shown in Table 4 below.

| | w or h | | | | |
|---|---|---|---|---|---|
| x or y | 4 | 8 | 16 | 32 | 64 |
| 0 | 24 | 44 | 40 | 36 | 52 |
| 1 | 6 | 25 | 27 | 27 | 44 |
| 2 | 2 | 14 | 19 | 21 | 37 |
| 3 | 0 | 8 | 13 | 16 | 31 |
| 4 | 0 | 4 | 9 | 12 | 26 |
| 5 | 0 | 2 | 6 | 9 | 22 |
| 6 | 0 | 1 | 4 | 7 | 18 |
| 7 | 0 | 1 | 3 | 5 | 15 |
| 8 | 0 | 0 | 2 | 4 | 13 |
| 9 | 0 | 0 | 1 | 3 | 11 |
| 10~63 | 0 | 0 | 0 | 0 | 0 |

According to inter prediction, a reference block which has the same or similar content with the current block is found in the previous coded/decoded picture to predict the current block. For video content with varying luminance, even if the reference block has the same content with the current block, the values of the samples in these two blocks may not be close to each other as these two blocks are in the two pictures with different luminance. Thus, to compensate the luminance changes from picture to picture in inter prediction, a linear model-based local luma compensation (“LIC”) is applied to the reference block to generate a predicted block having similar luminance level to the current block. Two parameters, the factor a and the offset b, are derived and applied to the reference block according to the following Equation 14:

$$y = a \times x + b$$

wherein x is the reference sample, and y is the predicted sample after luma compensation.

The model of luma compensation may be derived at picture-level and applied to all blocks within the picture, or derived at block-level and applied to that block only. Block-level luma compensation is also called LIC, wherein the decoder derives the parameters in the same way as the encoder, and parameters are not signaled. To derive the model parameters, the reconstructed samples and predicted samples of the neighboring blocks illustrated in shaded areas in FIG. 15 are used. First, linear model parameters are estimated according to a relationship between the predicted sample values and reconstructed sample values of the neighboring blocks. Then, the estimated linear model is applied on the predicted samples of the current block to generated luma compensated predicted block.

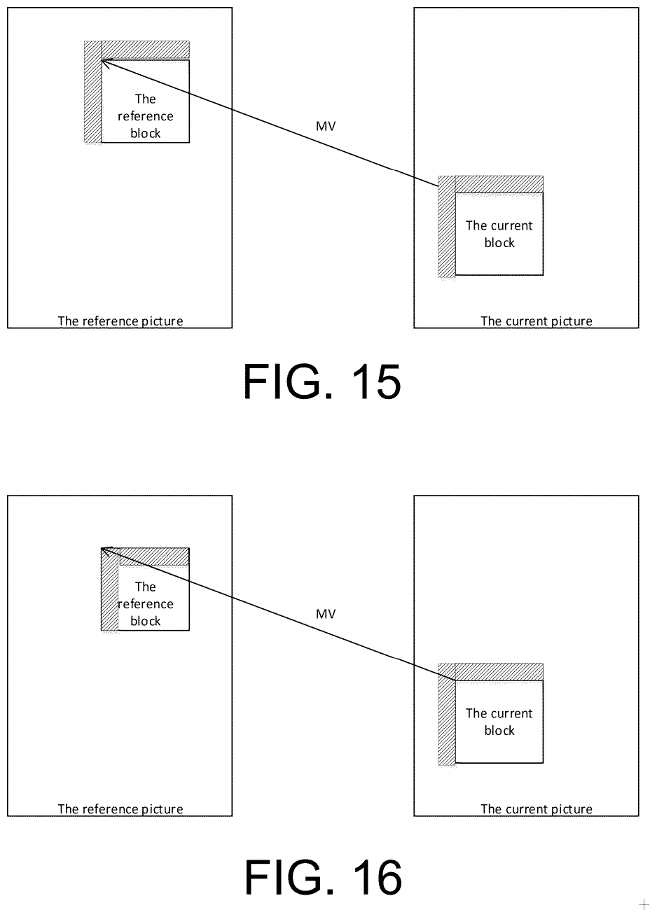

As the predicted samples of the neighboring block are used in the parameter estimation (the shaded area in the reference picture), the decoder must fetch a block larger than the current block from the reference picture buffer, which consumes bandwidth. To reduce bandwidth, current predicted block-based local luma compensation is performed, in which the predicted samples on the left and top boundary within the reference block are used to estimate the parameters instead of using the neighboring block samples. As shown with shaded areas in FIG. 16, the predicted samples within the left and up boundary of the reference block and the reconstructed samples of left and up neighboring blocks are used to derive the model parameters.

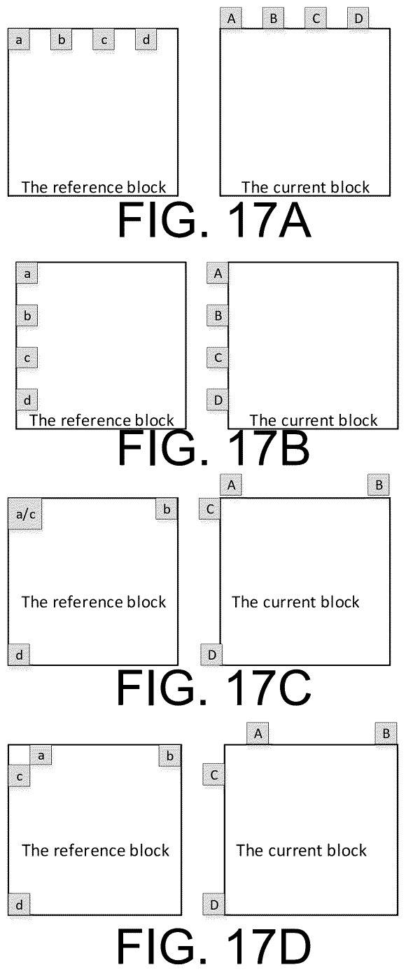

Least square estimation can be used to estimate the model parameters, but computational complexity is high. To simplify parameter estimation, four-point estimation is applied, wherein only four pairs of samples are used. As illustrated in FIG. 17A, four predicted samples at the top boundary within the reference block and four reconstructed samples of the top neighboring block are used; in FIG. 17B, four predicted samples at the left boundary within the reference block and four reconstructed samples of the left neighboring block are used; and in FIGS. 17C and 17D, two predicted samples at the top boundary and two predicted samples at the left boundary within the reference block, and two reconstructed samples of the top neighboring block and two reconstructed of the left neighboring block are used.

In the derivation process, first, samples “a”, “b”, “c”, “d” are sorted according to their values. The average of the two largest values among “a”, “b”, “c”, “d” is denoted as x_max, and the average of two corresponding sample values is denoted as y_max (A is corresponding to a, B is corresponding to b, C is corresponding to c and D is corresponding to d). The average of the two smallest values among “a”, “b”, “c”, “d” is denoted as x_min, and the average of two corresponding sample value is denoted as y_min. Next, the linear model parameters a and b are derived according to the following Equations 15 and 16:

$$a = ( ( y\_max - y\_min ) \times ( 1 << shift ) / ( x\_max - x\_min ) ) >> shift$$

$$b = y\_min - a \times x\_min$$

wherein “shift” is the bit shift number and “/” denotes integer division.

Template matching is a new inter prediction method (namely Inter TM) proposed for successor standards to AVS3, refining the motion vector derived in skip mode and direct mode based on template matching. At encoder-side, the process begins with using MVP list generation in skip mode and direct mode. Then, the first four MV candidates in the list are selected, which include one TMVP candidate and three Spatial MVP candidates with reference directions setting as bi-prediction, bi-prediction, uni-prediction, and uni-prediction, respectively. The reference information of the four candidates are shown in Table 5 below.

| | Order | | | |
|---|---|---|---|---|
| | 1 | 2 | 3 | 4 |
| | Type | | | |
| | TMVP | SMVP | | |
| Reference list | List 0 and list 1 | List 0 and list 1 | List 0 | List 1 |

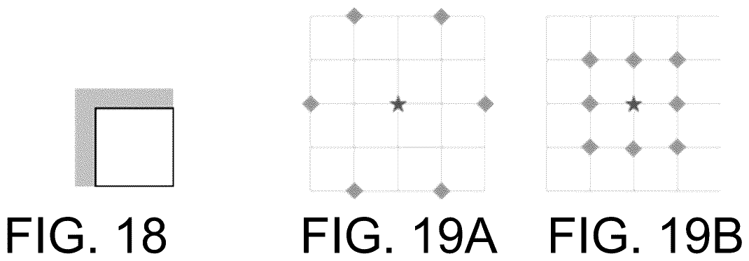

An encoder then removes duplicates from the MVPs by checking if the two bi-prediction candidates are identical, and rounds the MVPs to integer-pixel position. A template (with a width of 4) is constructed using the already-reconstructed pixels surrounding the current block, and the MVP list is sorted such that candidates with smaller template costs are placed at the front. The template shape is shown in FIG. 18. The template matching cost (“TM cost”) is calculated as the difference between the template of the current block which consists of the reconstructed samples as shown in FIG. 18 and the template of the reference block. Either the SAD or the sum of absolute transformed difference (“SATD”) is used as TM cost.

According to TM-based MVP refinement, a hexagonal search pattern is searched initially, performing up to 30 searches calculating the template cost by SAD. The point with the least TM cost is selected as the center for the next search iteration, and if the center point has least TM cost in a search iteration, the current hexagonal search terminates. Finally, a square-shape search pattern is searched once more to find the best MV. The MV refined by template matching is used as the final MV for the current block and used to generate the prediction block for the current block. The index of the best MVP is encoded into the bitstream using variable-length coding. Square-shape search and hexagonal-shape search patterns are illustrated in FIG. 19; other search patterns such as a cross-shape search pattern, a diamond-shape search pattern, and the like can also be used.

At decoder-side, a similar process is performed. Four MVP candidates are generated with the same method as the encoder, then de-duplication is performed and MV is rounded to integer-pixel positions. The MVPs are then sorted based on TM costs. With the candidate index decoded from the bitstream, the decoder can determine the selected candidate. After that, TM-based refinement is performed on the selected MVP candidate which is indicated by the candidate index signaled in the bitstream.

Adaptive Angular weighted prediction (“AAWP”) is an improved method based on AWP, proposed for successor standards to AVS3.

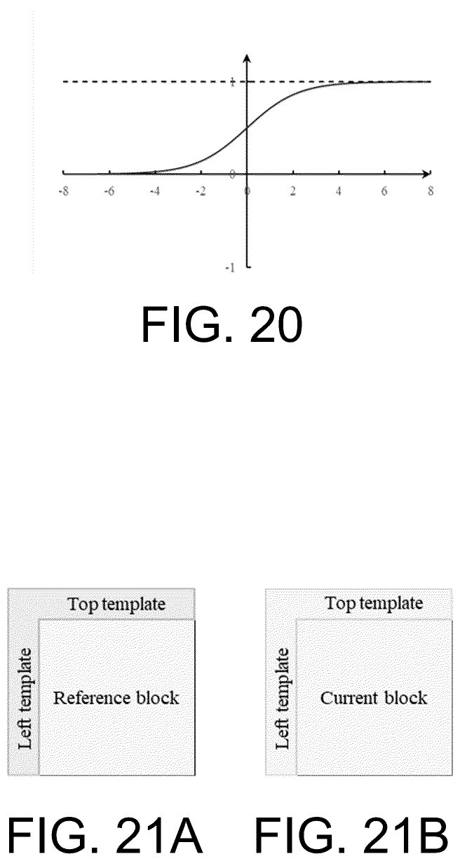

According to AAWP, first, a sigmoid function-based weight derivation method is introduced to derive the weight for each sample. This function takes the distance from the sample to the partition boundary (denoted as d, d having ½ pixel accuracy) as input, and outputs the weight of the each sample. The function is according to the following Equation 17:

$$f ( d ) = \frac{1}{1 + {e}^{- x * d}}$$

where d is distance, f(d) is weight, and x is the parameter of the sigmoid function. A weight distribution is illustrated in FIG. 20, where the x-axis is the distance from a weight to the partition boundary and y-axis represents the weight of that sample. There is a transition zone around the boundary. The weight of this transition zone is derived based on the sigmoid function.

To adapt to different video contents, the parameter x of the sigmoid function is not fixed, but selected by the encoder. In the current design, the parameter x is selected from parameter list {0.225, 0.45, 0.9, 1.8, 3.6} by the encoder. The encoder can use rate-distortion cost or other methods to determine the parameter used for the current AAWP CU and signal the index of the selected parameter in the bitstream. At decoder-side, by decoding the parameter index form the bitstream, the decoder can get the value of the parameter x used for the current AAWP coded CU. To increase the precision of the blending, the value range of weights is expanded from 0~16 to 0~32.

After weight derivation, the predicted values are derived according to the following Equation 18:

$$Pred ( x , y ) = ( P r e {d}_{0} ( x , y ) * {w}_{0} + P r e {d}_{1} * ( 32 - {w}_{0} ) + 16 ) >> 5$$

AWP supports eight weight prediction angles as illustrated in FIG. 8, and have seven weight array settings as illustrated in FIG. 9. Thus, there are 56 combinations, each of which has different sample weights for predictor blending. These 56 combinations are called 56 AWP modes. The mode used for the current AWP CU is determined by the encoder and indicated in the bitstream by the syntax element awp_index. At decoder-side, by decoding awp_index from the bitstream, the decoder can determine the AWP mode for the current CU. The syntax element awp_index is coded with truncated binary codes, with less value of awp_index taking less bits. The mapping from the awp_index to the AWP mode is fixed. To improve the coding efficiency of the awp_index and reduce the signaling cost, the mode reordering is proposed. The reordering method is summarized as follows:
At encoder-side, AWP modes are reordered the and the corresponding index of the reordered modes is signaled in the bitstream by syntax element dawp_mode_idx;
At decoder-side, AWP modes are also reordered to get a reordered AWP mode list, and the mode used is determined according to the value of dawp_mode_idx which is decoded from the bitstream;
The angle-weighted prediction value is derived according to the AWP mode used.

AWP mode reordering proceeds as follows:
Obtaining the reconstructed luma samples in the left neighboring column and the top neighboring row of the current block (which is called the template of the current block, illustrated by the unshaded L-shaped region in FIG. 21B) and the luma sample in the left neighboring column and the top neighboring row of the reference block (which is called template of the reference block, illustrated by the unshaded L-shaped region in FIG. 21A);
Deriving the weights of the sample in the template area (the left neighboring column and the top neighboring row) according to the AWP mode;
Calculating the angle-weighted prediction value of the samples in the template of the reference block according to the template sample weight;
Calculating, as a TM cost, the SAD between the angle-weighted prediction value of the samples in the template of the reference block and the reconstructed samples in the template of the current block; and
Reordering the AWP modes according to respective TM costs.

According to AWP mode as summarized above, the first candidate in the motion vector candidate list is the RPL0 motion of temporal motion vector predictor, and the following candidates are the uni-prediction motion vector candidates (each an SMVP) derived from four spatially neighboring blocks. If the candidate list is not full, four additional candidates are derived by scaling the first candidate (RPL0 motion of TMVP). According to example embodiments of the present disclosure, other types of MV candidates, such as HMVPs and non-adjacent MV candidates, can also be used to improve MV candidate accuracy for AWP mode.

According to example embodiments of the present disclosure, motion vector candidate list construction includes more MV candidates and additional types of MV candidates, and extends the candidate list length.

By way of example, after inserting all uni-prediction MVs derived from spatially neighboring blocks, if the MV candidate list is not full, the RPL1 motion information of the original bi-directional TMVP, is inserted into the list as an additional candidate. Then, if the list is still not full, an additional four candidates derived by scaling the first candidate (RPL0 motion of TMVP) are inserted to guarantee the list is full.

By way of another example, after inserting all uni-prediction MVs derived from spatially neighboring blocks, if the candidate list is not full, HMVPs are added. First, the HMVP table is traversed in inverse order, and either the RPL0 MV or RPL1 MV of each HMVP candidate in the table is alternatingly fetched and added into the candidate list according to the parity. That is, for the first HMVP candidate in the HMVP table, the RPL0 MV is used; for the second HMVP candidate in the HMVP table, the RPL1 MV is used; for the third HMVP candidate in the HMVP table, the RPL0 MV is used; for the fourth HMVP candidate in the HMVP table, the RPL1 MV is used; and so forth. After inserting all the HMVP candidates, if the list is still not full, an additional four candidates derived by scaling the first candidate (RPL0 motion of TMVP) are inserted to guarantee the list is full.

Alternatively, the HMVP table is traversed in inverse order, and if a current HMVP candidate is a uni-prediction MV, it is directly inserted into the candidate list. If a current HMVP candidate is a bi-prediction MV candidate, either the RPL0 MV or RPL1 MV is alternatingly fetched and added into the candidate list according to the parity. That is, for the first bi-prediction HMVP candidate in the HMVP table, the RPL0 MV is used; for the second bi-prediction HMVP candidate in the HMVP table, the RPL1 MV is used; for the third bi-prediction HMVP candidate in the HMVP table, the RPL0 MV is used; for the forth bi-prediction HMVP candidate in the HMVP table, the RPL1 MV is used; and so forth. After inserting all the HMVP candidates, if the list is still not full, the RPL1 motion information of the original bi-directional TMVP, is inserted into the list as an additional candidate. If the MV candidate is still not full, an additional four candidates derived by scaling the first candidate (RPL0 motion of TMVP) will be inserted to guarantee the list is full.

By way of another example, the candidate list length is extended from 5 to 6 or 7, and 1 MVP or 2 different-direction zero MVPs will considered to be added in the case that the MV candidate is not full.

By way of another example, the candidate list length is extended from 5 to 6 or 7 or 8 or 9 or 10 or 11 or 12 or 13 or 14 or 15. The candidate list is filled with motion information in the following order:
RPL1 MV of the original bi-directional TMVP;
Uni-prediction MV candidate (SMVPs) derived from spatially neighboring block;
Uni-prediction MV candidate derived from an HMVP;
Uni-prediction MV candidate derived from the spatial extension block;
RPL1 MV of motion information of the original bi-directional TMVP;
Four candidates derived by scaling the first candidate (RPL0 motion of TMVP);
Uni-prediction MV candidates derived by scaling SMVP candidate;
Uni-prediction MV candidates derived by offsetting the RPL1 MV of TMVP (e.g., adding 1 or −1 to RPL1 MV of TMVP); and
A zero MV.

If the above motion information is uni-directional, it is directly inserted into the candidate list. Otherwise, according to the index in the candidate list, either PRL0 MV or RPL1 MV is added to the list according to parity.

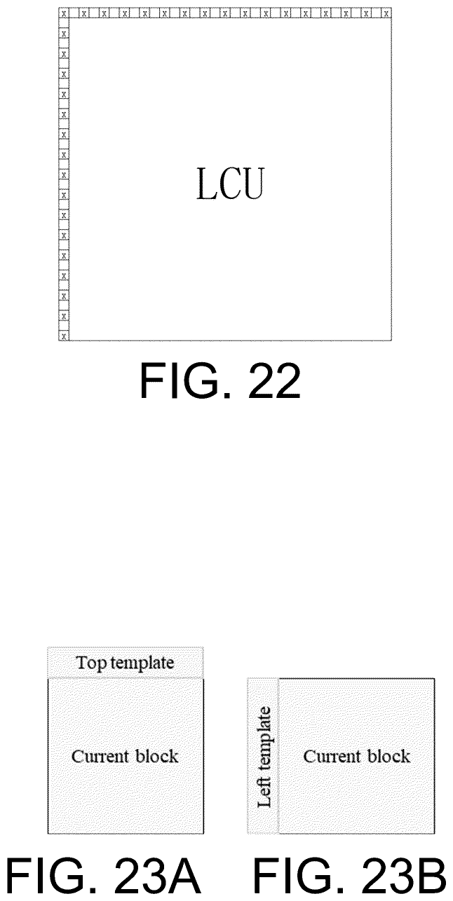

FIG. 22 illustrates spatial extension blocks. The spatial extension candidates are obtained from the left-adjacent and top-adjacent blocks of the largest coding unit (“LCU”) in which the current block is located. The order of checking the motion information of the spatial expansion candidates is: left neighbors (from bottom to top), top left neighbor, and top neighbor blocks (from left to right). The motion information of the 4×4 blocks is checked in this order and the RPL0 or PRL1 motion of these 4×4 blocks are fetched and inserted into the candidate list.

For efficiency, pruning is invoked in the MV candidate list construction: redundant, non-unique MV candidates will be removed from the list.

Improving the candidate list allows more accurate motion information to be used in AWP, but the order of the candidates in the currently constructed list may not be optimal. Thus, according to example embodiments of the present disclosure, a template constructed by using reconstructed pixels surrounding the current block is used to reorder the MV candidates.

Byway of example, the samples in the L-shaped area (i.e., the samples to the left, top and top-left of the current block, as illustrated in FIG. 18) adjacent to the current block are used as a template. The width and height of the template are set to 4 or 1 or 2. The unshaded L-shaped area in FIG. 21B is the template of the current block, and the unshaded L-shaped area in FIG. 21A is the template of the reference block referred to by the MV. The reference template also includes left neighboring columns and the top neighboring rows of the reference block. To get the sample values of the reference block template, interpolation is performed. The template interpolation filter can be a 12-tap filter, a 6-tap filter, or a 2-tap filter to generate a reference template. After getting the samples of the reference template, SAD between the samples in the template of the reference block and the reconstructed samples in the template of the current block is calculated as TM cost, and the MV candidates are reordered according to the TM cost from smallest to largest.

By way of another example, a template is constructed using left, top or top-left neighboring samples according to the prediction angles, as shown in Table 6 below. If a partition has only top neighboring samples, then only a top template (as illustrated by FIG. 23A) is used; if a partition has only left neighboring samples, then only left template (as illustrated by FIG. 23B) is used; and if a partition has both left and top neighboring samples, then both left and top templates (as illustrated in FIG. 21B) are used. The width and height of the template are set to 4 or 1 or 2. The template interpolation filter uses a 12-tap filter, a 6-tap filter, or a 2-tap filter to generate reference template. In this example, the ordering is performed at partition-level; that is, the first partition and the second partition have different orders of MV candidates as they use different template for reordering.

Currently, the candidates for Inter TM include 1 TMVP and 3 SMVPs. AWP also belongs to skip mode and direct mode. AWP divides the current block into 2 partitions, and each partition has its own motion information which is derived from blocks in the collocated picture and performs motion compensation independently.

According to example embodiments of the present disclosure, TM is applied to AWP mode. Motion information of each respective partition may or may not be refined by applying TM. When TM is applied, the template can be constructed using L-shaped area to the left, top and top-left of the current block, or can be constructed using left, top or top left neighboring samples according to partition angle, as shown in Table 1 above. The width and height of the template are set to 4 or 1 or 2. The template interpolation filter uses a 12-tap filter, a 6-tap filter, or a 2-tap filter to generate reference template. Similar with Inter TM, hexagonal or square search pattern can be used for motion refinement of each partition.

By way of example, AWP is applied at CU-level. A CU-level flag is signaled to indicate whether TM is applied to both partitions. When TM is used, two uni-prediction MVs are selected from the AWP candidate list and are both refined using the template matching refinement process as in the template matching.

By way of another example, AWP is applied at partition-level. Two partition-level flags, followed by the AWP mode indices and two merge indices, are signaled to indicate whether the motions are refined for two partitions, respectively.

Since AWP already has two flags to indicate whether UMVE-based MV refinement is used or not for the two partitions, in order to exclusively use these two coding tools, the TM flag is only signaled when both UMVE flags are false. When at least one of the UMVE flags is true, the TM flag is not signaled and inferred to be false so that AWP TM is disabled. Then, following the UMVE or TM flags, the AWP mode indices and two merge indices, are signaled to indicate the AWP mode and MV candidates used for two partitions.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 24 illustrates an example system 2400 for implementing the processes and methods described above for implementing angular weighted prediction.

The techniques and mechanisms described herein may be implemented by multiple instances of the system 2400 as well as by any other computing device, system, and/or environment. The system 2400 shown in FIG. 24 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 2400 may include one or more processors 2402 and system memory 2404 communicatively coupled to the processor(s) 2402. The processor(s) 2402 may execute one or more modules and/or processes to cause the processor(s) 2402 to perform a variety of functions. In some embodiments, the processor(s) 2402 may include a central processing unit (“CPU”), a graphics processing unit (“GPU”), both CPU and GPU, or other processing units or components known in the art. Additionally, each of the processor(s) 2402 may possess its own local memory, which also may store program modules, program data, and/or one or more operating systems.

Depending on the exact configuration and type of the system 2400, the system memory 2404 may be volatile, such as RAM, non-volatile, such as ROM, flash memory, miniature hard drive, memory card, and the like, or some combination thereof. The system memory 2404 may include one or more computer-executable modules 2406 that are executable by the processor(s) 2402.

The modules 2406 may include, but are not limited to, one or more of an encoder 2408 and a decoder 2410.

The encoder 2408 may be a VVC-standard encoder implementing any, some, or all aspects of example embodiments of the present disclosure as described above, and executable by the processor(s) 2402 to configure the processor(s) 2402 to perform operations as described above.

The decoder 2410 may be a VVC-standard encoder implementing any, some, or all aspects of example embodiments of the present disclosure as described above, executable by the processor(s) 2402 to configure the processor(s) 2402 to perform operations as described above.

The system 2400 may additionally include an input/output (“I/O”) interface 2440 for receiving image source data and bitstream data, and for outputting reconstructed pictures into a reference picture buffer or DPB and/or a display buffer. The system 2400 may also include a communication module 2450 allowing the system 2400 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 2430, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium 2430 is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-23B. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
constructing a uni-prediction motion candidate list comprising a first motion candidate comprising a reference picture list 0 MV or a reference picture list 1 MV of a temporal motion vector predictor (“TMVP”) candidate or of a history-based motion vector predictor (“HMVP”);
determining a uni-prediction motion candidate from the uni-prediction motion candidate list; and
performing, based on the uni-prediction motion candidate, angular weighted prediction upon a current block.

2. The computing system of claim 1, wherein the first motion candidate comprises a reference picture list 1 MV of a TMVP candidate.

3. The computing system of claim 1, wherein the uni-prediction motion candidate list further comprises a second motion candidate comprising a uni-prediction motion candidate derived by scaling the reference picture list 0 MV or the reference picture list 1 MV of the TMVP candidate.

4. The computing system of claim 1, wherein the first motion candidate comprises a reference picture list 0 MV or a reference picture list 1 MV of a HMVP candidate.

5. The computing system of claim 4, wherein the first motion candidate comprises a reference picture list 0 MV of a bi-directional HMVP candidate or a reference picture list 1 MV of the bi-directional HMVP candidate.

6. The computing system of claim 1, wherein the uni-prediction motion candidate list further comprises a second motion candidate comprising a motion vector of a left-adjacent or top-adjacent block of a largest coding unit (“LCU”) containing the current block.

7. The computing system of claim 1, wherein the uni-prediction motion candidate list further comprises a second motion candidate comprising a uni-prediction motion candidate derived by scaling a spatial motion vector predictor (“SMVP”) candidate.

8. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
inserting a plurality of motion candidates into a motion candidate list;
reordering motion candidate list from least to most template matching cost between samples of a template of a reference block and a template of a current block; and
performing, based on a motion candidate of the motion candidate list, angular weighted prediction upon the current block.

9. The computing system of claim 8, wherein samples of the template of the reference block and samples of the template of the current block are dependent on an angular weighted prediction mode by which angular weighted prediction is performed.

10. The computing system of claim 8, wherein samples of the template of the reference block and samples of the template of the current block respectively comprise top neighboring samples.

11. The computing system of claim 8, wherein samples of the template of the reference block and samples of the template of the current block respectively comprise left neighboring samples.

12. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
refining a first motion vector of a motion vector candidate list based on a first template matching cost between samples of a first template of a first reference block associated with the first motion vector and a first template of a current block;
signaling one or more flags in a bitstream associated with a video sequence indicating applying motion vector refinement based on template matching cost; and
performing angular weighted prediction according to a refined first motion vector.

13. The computing system of claim 12, wherein the one or more flags comprises a coding unit-level flag.

14. The computing system of claim 12, wherein the operations further comprise:
refining a second motion vector based on a second template matching cost between samples of a second template of a second reference block associated with the second motion vector and a second template of the current block; and
performing angular weighted prediction according to a refined second motion vector;
wherein the first template and the second template are dependent on an angular weighted prediction mode by which angular weighted prediction is performed.

15. The computing system of claim 14, wherein the refined first motion vector is obtained by minimizing the first template matching cost and the refined second motion vector is obtained by minimizing the second template matching cost.

16. A method, comprising:
decoding, from a bitstream associated with a video sequence, a flag indicating application of motion vector refinement based on template matching cost;
refining a first motion vector of a motion vector candidate list based on a first template matching cost between samples of a first template of a first reference block associated with the first motion vector and a first template of a current block; and
performing angular weighted prediction according to a refined first motion vector.

17. The method of claim 16, wherein the one or more flags comprises a coding unit-level flag.

18. The method of claim 16, further comprising:
refining a second motion vector based on a second template matching cost between samples of a second template of a second reference block associated with the second motion vector and a second template of the current block; and
performing angular weighted prediction according to a refined second motion vector;
wherein the first template and the second template are dependent on an angular weighted prediction mode by which angular weighted prediction is performed.

19. The method of claim 16, wherein the refined first motion vector is obtained by minimizing the first template matching cost and the refined second motion vector is obtained by minimizing the second template matching cost.

20. A method of storing a bitstream associated with a video sequence, the method comprising:
generating a bitstream comprising a flag indicating whether to apply motion vector refinement based template matching cost; and
storing the bitstream in a non-transitory computer-readable storage medium.
